(19) United States
(12) Patent Application Publication
(10) Pub. No.: US 2008/0213510 A1
(43) Pub. Date: Sep. 4, 2008

(54) Liquid Crystal Aligning Agent and Liquid Crystal Alignment Layer Formed Using the Same

(75) Inventors: Tae Hyoung KWAK, Goyang-si (KR); Jong Seob KIM, Daejeonkwangyeok-si (KR); Jae Min OH, Suwon-si (KR); Jae Deuk YANG, Osan-si (KR); Jeong Hoon KANG, Gunpo-si (KR); Won Seok DONG, Seongnam-si (KR); Ji Young JEONG, Seoul (KR); Sun Nyo YU, Anyang-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 11/967,374

(22) Filed: Dec. 31, 2007

(30) Foreign Application Priority Data
Mar. 2, 2007 (KR) 10-2007-0020714

(51) Int. Cl. C09K 19/38

(52) U.S. Cl. 428/1.26

(57) ABSTRACT

A liquid crystal aligning agent suitable for use in the production of a liquid crystal display device is provided. The liquid crystal aligning agent comprises at least one polymer selected from a polyamic acid and a soluble polyimide, an aprotic polar solvent and monoethylene glycol dimethyl ether or dipropylene glycol dimethyl ether. The liquid crystal aligning agent has satisfactory printability. Further provided is a liquid crystal alignment layer formed using the aligning agent. The liquid crystal alignment layer is highly uniform.

### CROSS-REFERENCE TO RELATED APPLICATION

This non-provisional application claims priority under 35 USC Section 119 from Korean Patent Application No. 10-2007-0020714, filed on Mar. 2, 2007, which is hereby incorporated by reference in its entirety.

### FIELD OF THE INVENTION

The present invention relates to a liquid crystal aligning agent suitable for producing a liquid crystal display device and a liquid crystal alignment layer formed using the aligning agent.

### BACKGROUND OF THE INVENTION

Liquid crystal display (LCD) devices are commonly produced by depositing a transparent conductive indium tin oxide (ITO) film on a glass substrate, applying a liquid crystal aligning agent thereto, curing the coated substrate by heating to form an alignment layer, laminating two panels to face each other through the alignment layer, and injecting a liquid crystal material into the alignment layer. Alternatively, a liquid crystal material is dropped onto a panel and another panel is laminated thereon (i.e. a liquid crystal dropping process), which is currently employed in the production lines of medium- and large-size LCDs, particularly, the fifth or higher generation production lines.

A typical liquid crystal aligning agent is in the form of a solution of a polymer resin. The liquid crystal aligning agent is applied to a substrate to form an alignment layer. Examples of suitable polymer resins are polyamic acids and polyimides. The polyamic acids are prepared by polycondensation of at least one aromatic dianhydride with at least one aromatic diamine, and the polyimides are prepared by cyclization (i.e. imidization) of the polyamic acids through dehydration. A general liquid crystal alignment layer is formed by dissolving a polyamic acid or a polyimide in an organic solvent to prepare a liquid crystal aligning agent, applying the liquid crystal aligning agent to a substrate by a flexo printing process, and preliminary drying and baking the coated substrate. In this regard, partial deviation of the thickness of the liquid crystal aligning layer may adversely affect displaying characteristics of a liquid crystal display device.

In an effort to solve this problem, a solvent mixture of 2-butylcellosolve (2-BC) and another solvent capable of readily dissolving a polyamic acid or a polyimide is currently used. In order to form uniform liquid crystal alignment layers, diethylene glycol diethyl ether can replace 2-BC (Japanese Patent Publication No. Hei 8-208983), and a mixture of diethylene glycol diethyl ether and dipropylene glycol monomethyl ether can also be used (Korean Patent Publication No. 2005-0106423) instead of 2-BC.

However, liquid crystal aligning agents using the above-mentioned solvents can exhibit poor adhesion to substrates despite their high viscosity, which can cause numerous defects and pinholes at the edges of the substrates.

### SUMMARY OF THE INVENTION

In accordance with one aspect of the present invention, there is provided a liquid crystal aligning agent that can exhibit excellent spreadability and adhesiveness to a substrate at the edge(s) thereof and satisfactory printability on the substrate. Further, the liquid crystal aligning agent of the invention can have substantially uniform and stable vertical alignment properties. The liquid crystal aligning agent of the invention can further exhibit substantially stable liquid alignment properties under various processing conditions with minimal or no deterioration of the vertical alignment of a liquid crystal material produced using a one-drop filling method.

The liquid crystal aligning agent of the invention can comprise:

a polyamic acid represented by Formula 1:

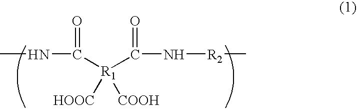

(wherein R₁ is a tetravalent organic group derived from an alicyclic or aromatic dianhydride and R₂ is a divalent organic group derived from an aromatic diamine), a soluble polyimide of Formula 2 which is prepared by imidization of the polyamic acid:

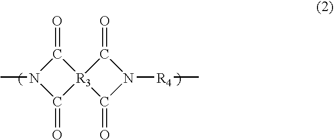

(wherein R₃ is a tetravalent organic group derived from an alicyclic or aromatic dianhydride and R₄ is a divalent organic group derived from an aromatic diamine), or a mixture thereof;

an aprotic polar solvent as a first solvent; and

dipropylene glycol dimethyl ether or monoethylene glycol dimethyl ether as a second solvent.

In accordance with another aspect of the present invention, there is provided a liquid crystal alignment layer which can exhibit high uniformity formed by applying the liquid crystal aligning agent to a substrate.

In accordance with still another aspect of the present invention, there is provided a liquid crystal display device comprising the liquid crystal alignment layer.

### BRIEF DESCRIPTION OF THE DRAWINGS

FIG. 1 is a photograph showing spreadability of a liquid crystal aligning agent prepared in Example 1.

FIG. 2 is a photograph showing spreadability of a liquid crystal aligning agent prepared in Example 4.

FIG. 3 is a photograph showing the spreadability of a liquid crystal aligning agent prepared in Comparative Example 1.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention provides a liquid crystal aligning agent comprising:

a polyamic acid represented by Formula 1:

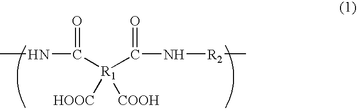

(wherein R₁ is a tetravalent organic group derived from an alicyclic or aromatic dianhydride and R₂ is a divalent organic group derived from an aromatic diamine), a soluble polyimide of Formula 2 which is prepared by imidization of the polyamic acid:

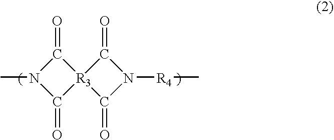

(wherein R₃ is a tetravalent organic group derived from an alicyclic or aromatic dianhydride and R₄ is a divalent organic group derived from an aromatic diamine), or a mixture thereof;

an aprotic polar solvent as a first solvent; and

dipropylene glycol dimethyl ether or monoethylene glycol dimethyl ether as a second solvent.

The polyamic acid used in the present invention is prepared by copolymerization of at least one aromatic diamine and at least one alicyclic or aromatic cyclic dianhydride.

Any known copolymerization process suitable for the preparation of polyamic acids using dianhydride and diamine compounds may be employed in the present invention.

Examples of aromatic diamines suitable for the preparation of the polyamic acid include, but are not limited to, p-phenylenediamine (p-PDA), 4,4-methylenedianiline (MDA), 4,4-oxydianiline (ODA), m-bisaminophenoxydiphenylsulfone (m-BAPS), p-bisaminophenoxydiphenylsulfone (p-BAPS), 2,2-bisaminophenoxyphenylpropane (BAPP) and 2,2-bisaminophenoxyphenylhexafluoropropane (HF-BAPP), 1,4-diamino-2-methoxybenzene, and the like, and mixtures thereof.

The divalent organic group derived from the aromatic diamine may be selected from the following structures:

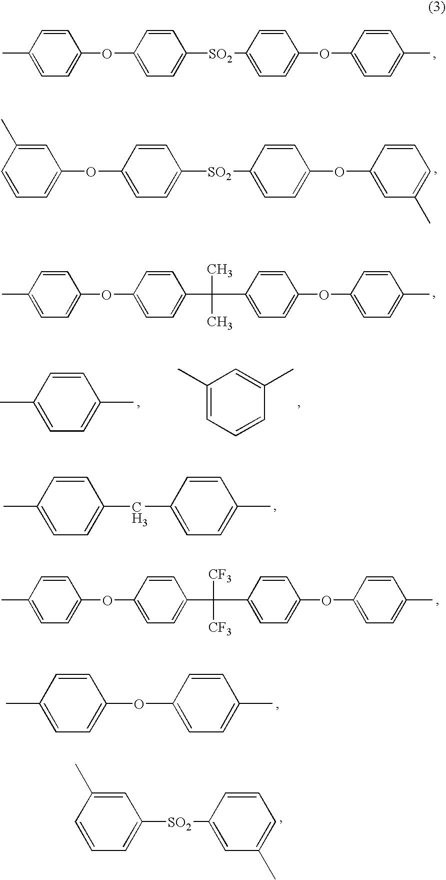

To control the pretilt angle of a liquid crystal material and allow the liquid crystal material to have excellent alignment properties, the polyamic acid can further include at least one compound selected from aromatic diamine compounds represented by Formulae 4, 5 and 6. These aromatic diamines are optional and can be present in addition to the diamines listed above.

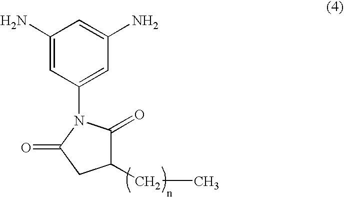

wherein n is an integer from 1 to 30;

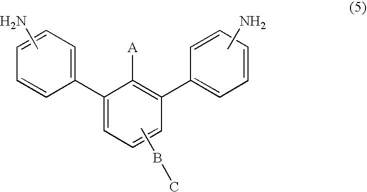

wherein A is a hydrogen atom or a methyl group, B is —O—, —COO—, —CONH—, —OCO— or —(CH₂)ₙ— (n is an integer from 1 to 10), and C is a C₁-C₂₀ linear, branched or cyclic alkyl group, or a C₆-C₃₀ aryl, arylalkyl or alkylaryl group whose one to ten hydrogen atoms from the terminals may be substituted with halogen groups and that may contain at least one functional group containing a heteroatom, which is selected from the group consisting of —O—, —COO—, —CONH— and —OCO—; and

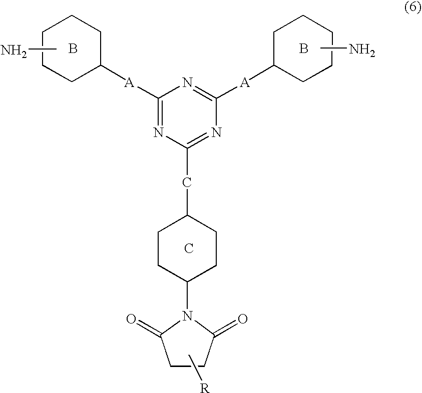

wherein each A is a single bond, —O—, —COO—, —CONH— or —OCO—, each B is independently a single bond, a benzene moiety or an C₁-C₂₀ alkyl-substituted benzene moiety or C₃-C₂₀ alicyclic moiety, C is a single bond, —O—, —COO—, —CONH— or —OCO—, D is a single bond or a benzene or C₃-C₂₀ alicyclic moiety, and R is a C₁-C₂₀ linear alkyl, branched or alicyclic alkyl group which may be substituted with at least one halogen atom.

The aromatic diamine compound can be included in an amount of from about 0.1 to about 50 mole %, for example from about 0.5 to about 30 mole %, and as another example from about 1 to about 20 mole %, based on the total moles of the diamine compounds used for the preparation of the polyamic acid.

Examples of suitable alicyclic dianhydrides for the preparation of the polyamic acid include without limitation 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclooctene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride, and 1,2,3,4-tetracarboxycyclopentane dianhydride, and the like, and mixtures thereof. The alicyclic dianhydride can be included in an amount of from about 5 to about 90 mole %, for example from about 10 to about 50 mole %, based on the total moles of the dianhydrides used for the preparation of the polyamic acid.

The tetravalent organic group derived from the alicyclic dianhydride may be selected from the following structures:

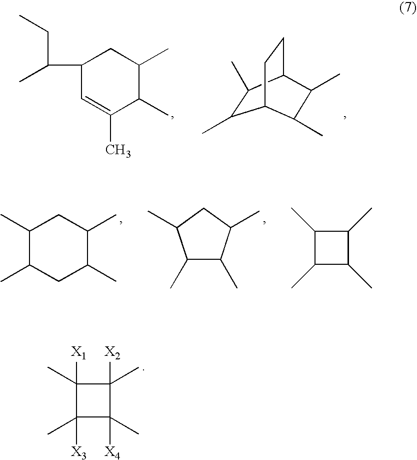

wherein each X₁, X₂, X₃, and X₄ is respectively —CH₃, —F, or —H.

Examples of suitable aromatic dianhydrides for the preparation of the polyamic acid include without limitation pyromellitic dianhydride (PMDA), biphthalic dianhydride (BPDA), oxydiphthalic dianhydride (ODPA), benzophenonetetracarboxylic dianhydride (BTDA) and hexafluoroisopropylidenediphthalic dianhydride (6-FDA), and the like, and mixtures thereof.

The aromatic cyclic dianhydride can be included in an amount of from about 10 to about 95 mole %, for example from about 50 to about 90 mole %, based on the total moles of the dianhydrides used for the preparation of the polyamic acid.

The tetravalent organic group derived from the aromatic dianhydride may be selected from the following structures (8):

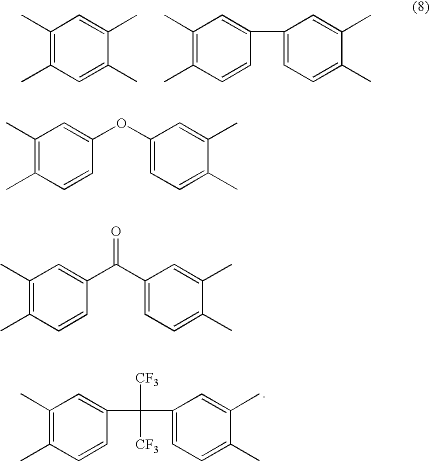

The polyamic acid can have a number-average molecular weight of about 10,000 to about 500,000 g/mol. The polyamic acid can have a glass transition temperature of from about 200° C. to about 350° C. depending on the degree of imidization or the structure of the polyamic acid.

At least a portion of the polyamic acid can be imidized into a soluble polyimide. The polyimide alone or its mixture with the polyamic acid may be used to produce a liquid crystal alignment layer. The polyamic acid may be imidized by the following three methods well known in the art.

1) Thermal imidization: A solution of polyamic acid can be applied to a substrate and thermally imidized in an oven or a hot plate at about 50° C. to about 250° C. The imidization of the polyamic acid does not substantially proceed below about 100° C. Accordingly, the optimum temperature for the imidization of the polyamic acid is in the range of about 150 to about 240° C. About 40 to about 80% of polyamic acid may be imidized depending on the polyamic acid.

2) Chemical imidization: An imidization catalyst and a dehydrating agent can be added to a solution of polyamic acid. This imidization can be carried out at a lower temperature than the thermal imidization. A tertiary amine such as pyridine, lutidine or triethylamine can be used as the imidization catalyst, and an acid anhydride such as acetic anhydride can be used as the dehydrating agent. The polyamic acid can be reacted with the dehydrating agent to induce cyclization for the imidization. In this regard, the molar ratio of the repeating units of the polyamic acid to the dehydrating agent is about 1:2. The cyclization rate varies depending on the imidization temperature. Accordingly, the use of the catalyst and the dehydrating agent at an optimal temperature enables a polyimide imidized at a desired rate. A temperature range for the imidization can be about 30° C. to about 150° C. A polyimide can be prepared at a higher rate by adding excessive amounts (≧3 moles) of the catalyst and the dehydrating agent at a reaction temperature lower than about 80° C., or relatively small amounts (≦3 moles) of the catalyst and the dehydrating agent at a reaction temperature higher than about 100° C.

3) Polycondensation of a tetracarboxylic dianhydride and a diisocyanate compound: Any aromatic or aliphatic diisocyanate compound may be used as the diisocyanate compound. Specific examples of such diisocyanate compounds include p-phenylene diisocyanate (PPDI), 1,6-hexamethylene diisocyanate (HDI), toluene diisocyanate (TDI), 1,5-naphthalene diisocyanate (NDI), isophorone diisocyanate (IPDI), 4,4-diphenylmethane diisocyanate (MDI), and cyclohexylmethane diisocyanate (H12MDI), and the like. These aromatic and aliphatic diisocyanate compounds may be used alone or as a mixture of thereof. The aromatic or aliphatic diisocyanate compound can be polycondensed with a tetracarboxylic dianhydride to produce a polyimide. A typical temperature for the polycondensation of the diisocyanate compound and the tetracarboxylic dianhydride is in the range of about 50° C. to about 200° C., for example about 90° C. to about 170° C.

The polyamic acid used in the present invention is commonly synthesized in an organic solvent at about 0 to about 150° C., for example about 0 to about 100° C. Any organic solvent may be used herein so long as it can dissolve the polymamic acid. Suitable organic solvents include without limitation N-methyl-2-pyrrolidone, N,N-dimethylacetamide, N,N-dimethylformamide, dimethylsulfoxide, γ-butyrolactone, and phenolic solvents such as m-cresol, phenol and halogenated phenols, and the like, and mixtures thereof. At least one solvent selected from the group consisting of pyrrolidones and lactones as the reaction solvent can be particularly useful to increase the solubility of the polymer. A mixture of a pyrrolidone and a lactone can also be useful in order to improve the wetting ability of the liquid crystal aligning agent and to prevent the liquid crystal aligning agent from absorbing moisture.

The polyamic acid used in the present invention can be highly soluble in general aprotic polar solvents such as N-methyl-2-pyrrolidone (NMP), γ-butyrolactone (GBL), dimethylformamide (DMF), dimethylacetamide (DMAc) and tetrahydrofuran (THF), and the like, and mixtures thereof. It is believed that the high solubility of the polyamic acid is largely attributed to the alicyclic dianhydride and a long alkyl side chain bonded to the functional diamine. The aprotic polar solvent can be present in the liquid crystal aligning agent in an amount of about 40 to about 95% by weight, for example about 30 to about 90%, based on the total weight of the solvents.

With recent demands for large-size, high-resolution and high-quality liquid crystal display devices, the printability of aligning agents has been of particular importance. Meanwhile, good solubility of aligning agents positively influences the printability of the aligning agents on substrates to form liquid crystal alignment layers.

The liquid crystal aligning agent of the present invention can comprise monoethylene glycol dimethyl ether or dipropylene glycol dimethyl ether as an organic solvent to ensure good spreadability and obtain a substantially uniform coating even with varying drying temperatures.

The monoethylene glycol dimethyl ether or dipropylene glycol dimethyl ether can be present in an amount of about 5 to about 60% by weight, for example about 20 to about 60% by weight, based on the total weight of all solvents used. When the organic solvent is present in an amount of less than about 5% by weight, its addition effects are trivial. Meanwhile, when the organic solvent is present in an amount exceeding about 60% by weight, precipitation of the polyamic acid or the soluble polyimide may occur.

If necessary, the liquid crystal aligning agent of the present invention may further comprise about 1 to about 50% by weight of 2-butylcellosolve (2-BC), based on the total weight of all solvents used. The 2-butylcellosolve (2-BC) is added to improve the defoaming properties of the liquid crystal aligning agent.

A combination of poor solvents such as alcohols, ketones, esters, ethers, hydrocarbons and halogenated hydrocarbons in an optimal ratio may be used in the present liquid crystal aligning agent so long as it does not cause the precipitation of the polyamic acid. These poor solvents serve to lower the surface energy of the solution of the aligning agent to achieve good spreadability and uniformity of the solution upon application. The poor solvents can be used in an amount of about 1 to about 90% by weight, for example about 1 to about 70% by weight, based on the total weight of all solvents used. Specific examples of the poor solvents include without limitation methanol, ethanol, isopropanol, cyclohexanol, ethylene glycol, propylene glycol, 1,4-butanediol, triethylene glycol, acetone, methyl ethyl ketone, cyclohexanone, methyl acetate, ethyl acetate, butyl acetate, diethyl acetate, malonic acid ester, diethyl ether, ethylene glycol monomethyl ether, ethylene glycol monoethyl ether, ethylene glycol phenyl ether, ethylene glycol phenyl methyl ether, ethylene glycol phenyl ethyl ether, ethylene glycol dimethyl ethyl ether, diethylene glycol dimethyl ethyl ether, diethylene glycol ether, diethylene glycol monomethyl ether, diethylene glycol monoethyl ether, diethylene glycol monomethyl ether acetate, diethylene glycol monoethyl ether acetate, ethylene glycol methyl ether acetate, ethylene glycol ethyl ether acetate, 4-hydroxy-4-methyl-2-pentanone, ethyl 2-hydroxyethylpropionate, ethyl 2-hydroxyethyl-2-methylpropionate, ethoxyethyl acetate, hydroxyethyl acetate, methyl 2-hydroxy-3-methylbutanoate, methyl 3-methoxypropionate, ethyl 3-methoxypropionate, ethyl 3-ethoxypropionate, methyl 3-ethoxypropionate, methyl methoxy butanol, ethyl methoxy butanol, methyl ethoxy butanol, ethyl ethoxy butanol, tetrahydrofuran, dichloromethane, 1,2-dichloroethane, 1,4-dichlorobutane, trichloroethane, chlorobenzene, o-dichlorobenzene, hexane, heptane, octane, benzene, toluene, and xylene, and the like, and mixtures thereof.

For better reliability and electrooptical properties, the liquid crystal aligning agent of the present invention may further comprise at least one epoxy compound having two to four epoxy groups. The epoxy compound can be mixed in an amount of about 0.01 to about 50 parts by weight, for example about 1 to about 30 parts by weight, based on 100 parts by weight of the polyamic acid, the polyimide or a mixture thereof. The use of the epoxy compound in an amount more than about 30 parts by weight may deteriorate the printability and uniformity of the liquid crystal aligning agent on a substrate. Meanwhile, the use of the epoxy compound in an amount less than about 1 part by weight does not produce any significant effect.

Exemplary epoxy compounds useful in the invention are represented by Formula 9:

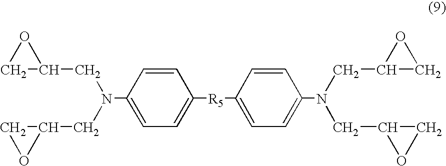

wherein R₅ is an C6-C30 aromatic or C₁-C₄ alicyclic divalent organic group.

In the compound of Formula 9, four glycidyl groups are bonded to a diaminophenyl moiety. Specific examples of the epoxy compound include without limitation N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, and N,N,N′,N′-tetraglycidyl-4,4′-diaminobenzene, and the like, and mixtures thereof.

The liquid crystal aligning agent of the present invention may further comprise one or more additives selected from surfactants, coupling agents and the like, and mixtures thereof. These additives are used to improve the printability of the liquid crystal aligning agent.

The liquid crystal aligning agent can include the solids in an amount of about 0.01 to about 15% by weight, and a viscosity of liquid crystal aligning agent can be about 3 to about 30 cps. Below about 3 cps, numerous defects and pinholes may be left on a substrate. Above about 30 cps, printability of the agent may deteriorate, and a substrate may not be coated sufficiently and uniformly.

The liquid crystal aligning agent of the present invention can be used to form a liquid crystal alignment layer. Specifically, the liquid crystal alignment layer can be formed by filtering the liquid crystal aligning agent and applying the filtrate to a substrate by spin coating, flexo printing, ink jet printing, and other suitable processes. Flexo printing can provide coating uniformity and ease of large-area printing. Any transparent substrate may used in the present invention. For example, glass and plastics such as acrylic and polycarbonate resins may be used for a substrate. A substrate having an ITO electrode thereon for liquid crystal driving can simplify processing.

First, the liquid crystal aligning agent of the present invention can be substantially uniformly applied to the substrate to ensure increased coating uniformity. Then, the coating layer can be preliminarily dried. The preliminary drying step can be performed at an ambient temperature to about 200° C., for example about 30° C. to about 150° C., and as another example about 40° C. to about 120° C., for about 1 to about 100 minutes. The volatility of each of the components of the liquid crystal aligning agent can be adjusted to form a substantially uniform coating layer with minimal or no thickness deviation. Thereafter, the coating layer can be baked at a temperature of about 80 to about 300° C., for example about 120 to about 280° C., for about 5 to about 300 minutes to remove the remaining portion of the solvents completely, to produce a liquid crystal alignment layer. The liquid crystal alignment layer may be subjected to a uniaxial orientation process by rubbing or irradiation with polarized UV light. The liquid crystal alignment layer may not undergo a uniaxial orientation process in some applications (e.g., a vertical alignment layer). The liquid crystal alignment layer can be used to produce a liquid crystal display device.

The present liquid crystal aligning agent can produce a substantially uniform liquid crystal alignment layer. Therefore, the present liquid crystal alignment layer can produce a large liquid crystal display device in a high yield.

Hereinafter, the present invention will be explained in more detail with reference to the following examples. However, these examples are given for the purpose of illustration and are not intended to limit the present invention.

### EXAMPLES

### Synthesis Example 1

0.5 moles of phenylenediamine and 0.5 moles of 3,5-diaminophenyldecyl succinimide (a diamine represented by Formula 4) are put into a four-neck flask equipped with a stirrer, a thermostat, a nitrogen injection system and a condenser while passing nitrogen through the flask. The mixture is dissolved in N-methyl-2-pyrrolidone (NMP). To the solution is added 1.0 mole of 1,2,3,4-cyclobutanetetracarboxylic dianhydride in a solid form with vigorous stirring. At this time, the solids content of the mixture is 1.5% by weight. The mixture is allowed to react for 10 hours while maintaining a reaction temperature at 30-50° C. to prepare a solution of a polyamic acid. 3.0 moles of acetic anhydride and 5.0 moles of pyridine are added to the polyamic acid solution, heated to 80° C., and allowed to react for 6 hours. Vacuum distillation of the reaction mixture is performed to remove the catalyst and the solvents, giving a soluble polyimide resin (SPI-1) having a solids content of 30%. N-methyl-2-pyrrolidone (NMP) or γ-butyrolactone is added to the soluble polyimide resin and stirred at room temperature for 24 hours to prepare a solution of the soluble polyimide resin (SPI-1).

### Synthesis Example 2

A soluble polyimide resin (SPI-2) is prepared in the same manner as in Synthesis Example 1, except that 0.5 moles of 3,5-bis(3-aminophenyl)-methylphenoxytrifluoropentadecane (a diamine represented by Formula 5) is used for the polymerization.

### Synthesis Example 3

A soluble polyimide resin (SPI-3) is prepared in the same manner as in Synthesis Example 1, except that 0.5 moles of 2,4-dinitrophenoxy-6-hexadecyl-1,3,5-triazine (a diamine represented by Formula 6) is used for the polymerization.

### Example 1

22 g of the soluble polyimide (SPI-1) prepared in Synthesis Example 1 is diluted with 1.98 g of NMP and 31.02 g of monoethylene glycol dimethyl ether with stirring in a 100 ml flask with a side arm at room temperature for 24 hours to prepare a liquid crystal aligning agent. The liquid crystal aligning agent is measured to have a solids content of 8% and a viscosity of 25 cps.

The liquid crystal aligning agent is dropped onto a clean ITO-coated glass substrate using a microsyringe and allowed to stand for 10-30 minutes. The spreading of the liquid crystal aligning agent is observed under an electron microscope (MX-50, Olympus). As a result, the liquid crystal aligning agent is spread at a distance of 10-30 mm from a position of the substrate where the liquid crystal aligning agent was dropped (FIG. 1). Further, the liquid crystal aligning agent is printed on the substrate by flexo printing using an alignment-layer coating system (CZ 200, Nakan). The resulting substrate is allowed to stand at room temperature for 0-5 minutes and preliminarily dried on a hot plate at temperatures of 50° C., 70° C. and 90° C. at 2-5 minutes to form a coating. The surface of the coating is visually observed. The uniformity of the coating is evaluated by measuring variations in the thickness of the coating at the respective preliminary drying temperatures using an electron microscope. The results are shown in Table 1.

The dried substrate is baked on a hot plate at temperatures of 200° C. and 230° C. for 10-30 minutes to form a liquid crystal alignment layer. The uniformity of the liquid crystal alignment layer is evaluated and the results are shown in Table 1.

### Example 2

22 g of the soluble polyimide (SPI-1) prepared in Synthesis Example 1 is diluted with 1.98 g of NMP, 20.68 g of monoethylene glycol dimethyl ether and 10.34 g of 2-butylcellosolve (2-BC) as a poor solvent with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 3

22 g of the soluble polyimide (SPI-1) prepared in Synthesis Example 1 is diluted with 1.98 g of NMP and 31.02 g of dipropylene glycol dimethyl ether with stirring in a 100 ml flask with a side arm at room temperature for 24 hours to prepare a liquid crystal aligning agent. The liquid crystal aligning agent is measured to have a solids content of 8% and a viscosity of 25 cps.

The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 4

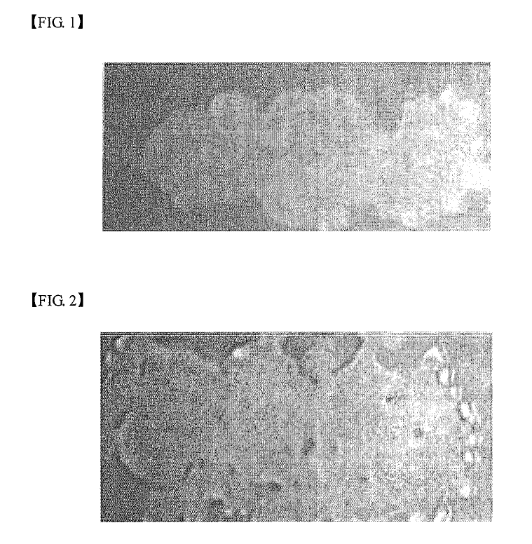

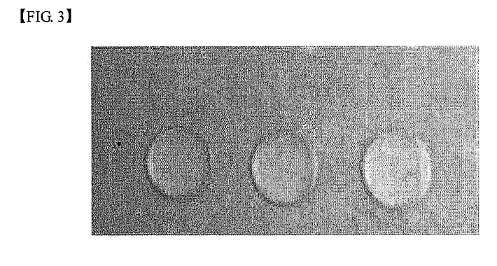

22 g of the soluble polyimide (SPI-1) prepared in Synthesis Example 1 is diluted with 1.98 g of NMP, 20.68 g of dipropylene glycol dimethyl ether and 10.34 g of 2-butylcellosolve (2-BC) as a poor solvent with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1. On the other hand, the liquid crystal aligning agent is dropped onto the substrate. The liquid crystal aligning agent is observed to be spread at a distance of 10-30 mm from a position of the substrate where the liquid crystal aligning agent is dropped (FIG. 2).

### Example 5

22 g of the soluble polyimide (SPI-2) prepared in Synthesis Example 2 is diluted with 1.98 g of NMP and 31.02 g of monoethylene glycol dimethyl ether with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 6

22 g of the soluble polyimide (SPI-2) prepared in Synthesis Example 2 is diluted with 1.98 g of NMP, 20.68 g of monoethylene glycol dimethyl ether and 10.34 g of 2-butylcellosolve (2-BC) as a poor solvent with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 7

22 g of the soluble polyimide (SPI-2) prepared in Synthesis Example 2 is diluted with 1.98 g of NMP and 31.02 g of dipropylene glycol dimethyl ether with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 8

22 g of the soluble polyimide (SPI-2) prepared in Synthesis Example 2 is diluted with 1.98 g of NMP, 20.68 g of dipropylene glycol dimethyl ether and 10.34 g of 2-butylcellosolve (2-BC) as a poor solvent with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 9

22 g of the soluble polyimide (SPI-3) prepared in Synthesis Example 3 is diluted with 1.98 g of NMP and 31.02 g of monoethylene glycol dimethyl ether with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 10

22 g of the soluble polyimide (SPI-3) prepared in Synthesis Example 3 is diluted with 1.98 g of NMP, 20.68 g of monoethylene glycol dimethyl ether and 10.34 g of 2-butylcellosolve (2-BC) as a poor solvent with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 11

22 g of the soluble polyimide (SPI-3) prepared in Synthesis Example 3 is diluted with 1.98 g of NMP and 31.02 g of dipropylene glycol dimethyl ether with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Example 12

22 g of the soluble polyimide (SPI-3) prepared in Synthesis Example 3 is diluted with 1.98 g of NMP, 20.68 g of dipropylene glycol dimethyl ether and 10.34 g of 2-butylcellosolve (2-BC) as a poor solvent with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Comparative Example 1

22 g of the soluble polyimide (SPI-1) prepared in Synthesis Example 1 is diluted with 1.98 g of NMP and 31.02 g of 2-butylcellosolve (2-BC) with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate is evaluated in accordance with the procedure described in Example 1. The results are shown in FIG. 3. The photograph of FIG. 3 shows that the liquid crystal aligning agent is not spread from a position of the substrate where the liquid crystal aligning agent is dropped. After the liquid crystal aligning agent is printed and preliminarily dried to form a coating, the printability of the liquid crystal aligning agent is observed. When the liquid crystal aligning agent is dried at 50° C., 60° C. and 70° C., variations in the thickness of the coating are measured to be between 0.01 and 0.05 μm, indicating that the coating is not uniform. The dried substrate is baked in the manner described in Example 1 to form a liquid crystal alignment layer. However, no significant decrease in thickness variation is not observed. In the case where the preliminary drying temperatures are relatively low, the liquid crystal alignment layer is not uniform.

### Comparative Example 2

22 g of the soluble polyimide (SPI-2) prepared in Synthesis Example 2 is diluted with 1.98 g of NMP and 31.02 g of 2-butylcellosolve (2-BC) with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

### Comparative Example 3

22 g of the soluble polyimide (SPI-3) prepared in Synthesis Example 3 is diluted with 1.98 g of NMP and 31.02 g of 2-butylcellosolve (2-BC) with stirring in a 100 ml flask with a side arm at room temperature for 24 hours to prepare a liquid crystal aligning agent. The liquid crystal aligning agent is measured to have a solids content of 8% and a viscosity of 25 cps. The spreadability of the liquid crystal aligning agent on a substrate and the uniformity of a coating formed using the liquid crystal aligning agent at various drying temperatures are evaluated in accordance with the respective procedures described in Example 1. The results are shown in Table 1.

TABLE 1

| | | | | | | | | | Uniformity of | |
|---|---|---|---|---|---|---|---|---|---|---|
| | | | | | | Uniformity of coating at | | | coating at | |
| | | | | | | preliminary | | | final drying | |
| | | | | Additional | | drying temperatures | | | temperatures | |
| | Polymer | Solvent(s) | w/w | solvent | Spreadability | 50° C. | 70° C. | 90° C. | 200° C. | 230° C. |
| Example 1 | SPI-1 | MEGDE¹⁾/2-BC | 60/0 | NMP/GBL | Good | Good | Good | Good | Good | Good |
| Example 2 | SPI-1 | MEGDE/2-BC | 40/20 | NMP/GBL | Good | Good | Good | Good | Good | Good |
| Example 3 | SPI-1 | DPGDE²⁾/2-BC | 60/0 | NMP/GBL | Good | Good | Good | Good | Good | Good |
| Example 4 | SPI-1 | DPGDE/2-BC | 40/20 | NMP/GBL | Good | Good | Good | Good | Good | Good |
| Example 5 | SPI-2 | MEGDE/2-BC | 60/0 | NMP/GBL | Good | Good | Good | Good | Good | Good |
| Example 6 | SPI-2 | MEGDE/2-BC | 40/20 | NMP/GBL | Good | Good | Good | Good | Good | Good |
| Example 7 | SPI-2 | DPGDE/2-BC | 60/0 | NMP/GBL | Good | Good | Good | Good | Good | Good |
| Example 8 | SPI-2 | DPGDE/2-BC | 40/20 | NMP/GBL | Good | Good | Good | Good | Good | Good |
| Example 9 | SPI-3 | MEGDE/2-BC | 60/0 | NMP/GBL | Good | Good | Good | Good | Good | Good |
| Example 10 | SPI-3 | MEGDE/2-BC | 40/20 | NMP/GBL | Good | Good | Good | Good | Good | Good |
| Example 11 | SPI-3 | DPGDE/2-BC | 60/0 | NMP/GBL | Good | Good | Good | Good | Good | Good |
| Example 12 | SPI-3 | DPGDE/2-BC | 40/20 | NMP/GBL | Good | Good | Good | Good | Good | Good |
| Comparative Example 1 | SPI-1 | 2-BC | 60 | NMP/GBL | Poor | Poor | Poor | Good | Poor | Poor |
| Comparative Example 2 | SPI-2 | 2-BC | 60 | NMP/GBL | Poor | Poor | Poor | Good | Poor | Poor |
| Comparative Example 3 | SPI-3 | 2-BC | 60 | NMP/GBL | Poor | Poor | Poor | Good | Poor | Poor |

¹⁾monoethylene glycol dimethyl ether
²⁾dipropylene glycol dimethyl ether

Criteria for Evaluation of Spreadability:

0.001 ml of each of the liquid crystal aligning agents are dropped onto a clean ITO-coated glass substrate using a microsyringe and allowed to stand for 10-30 minutes. The spreadability of the liquid crystal aligning agent is evaluated by measuring the distance by which the liquid crystal aligning agent spread from a dropping point. Specifically, the spreadability of the liquid crystal aligning agent is judged to be ‘good’ when the distance is more than 10 mm, ‘fair’ when the distance is between 5 and 10 mm, or ‘poor’ when the distance is less than 5 mm.

Criteria for Evaluation of Uniformity:

Each of the liquid crystal aligning agents is printed on an ITO-coated glass substrate by flexo printing using an alignment-layer coating system (CZ 200, Nakan). The resulting substrate is allowed to stand at room temperature for 1-5 minutes and preliminarily dried on a hot plate at temperatures of 50° C., 70° C. and 90° C. at 2-5 minutes to form a coating layer. The surface of the coating layer is visually observed. The uniformity of the coating layer is evaluated by measuring deviation in thickness of the coating layer over the entire surface of the substrate at the respective preliminary drying temperatures using an electron microscope (MX-50, Olympus). Specifically, the uniformity of the coating layer is judged to be ‘good’ when the variation is less than 0.005 μm, ‘fair’ when the variation is between 0.005 and 0.01 μm, and ‘poor’ when the variation is more than 0.01 μm.

The dried substrate is baked on a hot plate at temperatures of 200° C. and 230° C. for 10-300 minutes to form a liquid crystal alignment layer. The uniformity of the liquid crystal alignment layer is evaluated based on the criteria defined above.

As apparent from the above description, the liquid crystal aligning agent of the present invention exhibits excellent characteristics in terms of spreadability and uniformity, resulting in satisfactory printability on a substrate. In addition, a substantially uniform liquid crystal alignment layer (for example, a liquid crystal alignment layer which is substantially free of solvent, such as the layers described herein following the final drying step at temperatures of 200° C. and 230° C., and having “good” uniformity determined using the above procedure and criteria) can be formed using the liquid crystal aligning agent of the present invention regardless of preliminary drying temperatures.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A liquid crystal aligning agent comprising:
a polyamic acid represented by Formula 1: 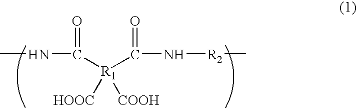
wherein R₁ is a tetravalent organic group derived from an alicyclic or aromatic dianhydride and R₂ is a divalent organic group derived from an aromatic diamine, a polyimide of Formula 2 which is prepared by imidization of the polyamic acid: 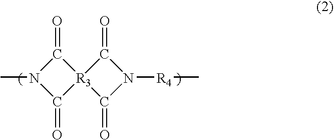
wherein R₃ is a tetravalent organic group derived from an alicyclic or aromatic dianhydride and R₄ is a divalent organic group derived from an aromatic diamine, or a mixture thereof;
an aprotic polar solvent as a first solvent; and
dipropylene glycol dimethyl ether or monoethylene glycol dimethyl ether as a second solvent.

2. The liquid crystal aligning agent according to claim 1, wherein the polyamic acid has a number-average molecular weight of about 10,000 to about 500,000 g/mol.

3. The liquid crystal aligning agent according to claim 1, wherein the first aprotic polar solvent comprises a solvent selected from the group consisting of N-methyl-2-pyrrolidone (NMP), γ-butyrolactone (GBL), dimethylformamide (DMF), dimethylacetamide (DMAc), tetrahydrofuran (THF), and mixtures thereof.

4. The liquid crystal aligning agent according to claim 1, wherein the first solvent comprises N-methyl-2-pyrrolidone (NMP) present in an amount of about 40 to about 95% by weight and the second solvent is present in an amount of about 5 to about 60% by weight, based on the total weight of the solvents.

5. The liquid crystal aligning agent according to claim 1, further comprising 2-butylcellosolve (2-BC).

6. The liquid crystal aligning agent according to claim 5, wherein the first solvent is present in an amount of about 30 to about 90% by weight, the second solvent is present in an amount of about 5 to about 60% by weight and the 2-butylcellosolve (2-BC) is present in an amount of about 1 to about 50% by weight, based on the total weight of the solvents.

7. The liquid crystal aligning agent according to claim 1, wherein the aromatic diamine comprises at least one compound selected from the group consisting of p-phenylenediamine (p-PDA), 4,4-methylenedianiline (MDA), 4,4-oxydianiline (ODA), m-bisaminophenoxydiphenylsulfone (m-BAPS), p-bisaminophenoxydiphenylsulfone (p-BAPS), 2,2-bisaminophenoxyphenylpropane (BAPP), 2,2-bisaminophenoxyphenylhexafluoropropane (HF-BAPP) and 1,4-diamino-2-methoxybenzene.

8. The liquid crystal aligning agent according to claim 1, wherein the aromatic diamine comprises at least one compound selected from aromatic diamine compounds represented by Formulae 4, 5 and 6: 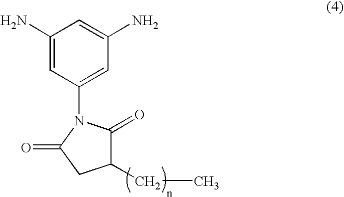
wherein n is an integer from 1 to 30; 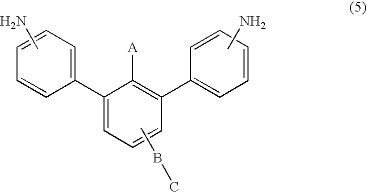
wherein A is a hydrogen atom or a methyl group, B is —O—, —COO—, —CONH—, —OCO— or —(CH₂)ₙ— wherein n is an integer from 1 to 10, and C is a C₁-C₂₀ linear, branched or cyclic alkyl group, or a C₆-C₃₀ aryl, arylalkyl or alkylaryl group whose one to ten hydrogen atoms from the terminals are unsubstituted or substituted with halogen groups and that contains no heteroatom or at least one heteroatom selected from the group consisting of —O—, —COO—, —CONH— and —OCO—; and 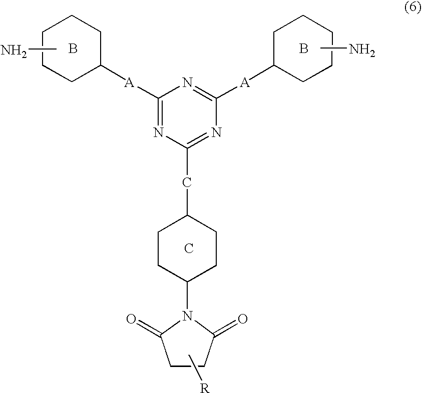
wherein each A is a single bond, —O—, —COO—, —CONH— or —OCO—, each B is a single bond, a benzene moiety or an alkyl-substituted benzene or alicyclic moiety, C is a single bond, —O—, —COO—, —CONH— or —OCO—, D is a single bond or a benzene or alicyclic moiety, and R is a C₁-C₂₀ linear alkyl, branched or alicyclic alkyl group which is unsubstituted or substituted with at least one halogen atom.

9. The liquid crystal aligning agent according to claim 8, wherein the aromatic diamine comprises at least one compound selected from the group consisting of 3,5-diaminophenyldecyl succinimide, 3,5-bis(3-aminophenyl)-methylphenoxytrifluoropentadecane, and 2,4-dinitrophenoxy-6-hexadecyl-1,3,5-triazine.

10. The liquid crystal aligning agent according to claim 1, further comprising about 1 to about 30 parts by weight of at least one epoxy compound having two to four epoxy groups, based on 100 parts by weight of the polyamic acid, the polyimide or a mixture thereof.

11. The liquid crystal aligning agent according to claim 1, wherein the liquid crystal aligning agent has a solids content of about 0.01 to about 15% by weight.

12. The liquid crystal aligning agent according to claim 1, wherein the liquid crystal aligning agent has a viscosity of about 3 to about 30 cps.

13. A substantially uniform liquid crystal alignment layer comprising a polyimide of Formula 2 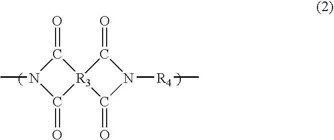
wherein R₃ is a tetravalent organic group derived from an alicyclic or aromatic dianhydride and R₄ is a divalent organic group derived from an aromatic diamine, wherein said alignment layer is substantially free of solvents and exhibits a variation in thickness of less than 0.005 μm.

14. The substantially uniform liquid crystal alignment layer of claim 13, wherein the aromatic diamine comprises at least one compound selected from aromatic diamine compounds represented by Formulae 4, 5 and 6: 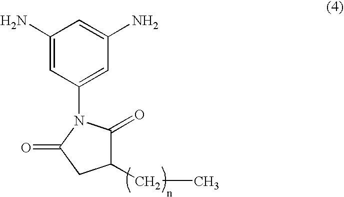
wherein n is an integer from 1 to 30; 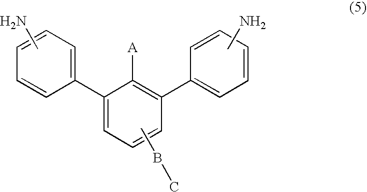
wherein A is a hydrogen atom or a methyl group, B is —O—, —COO—, —CONH—, —OCO— or —(CH₂)ₙ— wherein n is an integer from 1 to 10, and C is a C₁-C₂₀ linear, branched or cyclic alkyl group, or a C₆-C₃₀ aryl, arylalkyl or alkylaryl group whose one to ten hydrogen atoms from the terminals are unsubstituted or substituted with halogen groups and that contains no heteroatom or at least one heteroatom selected from the group consisting of —O—, —COO—, —CONH— and —OCO—; and 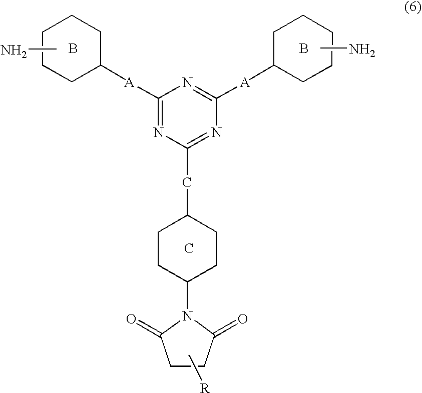
wherein each A is a single bond, —O—, —COO—, —CONH— or —OCO—, each B is a single bond, a benzene moiety or an alkyl-substituted benzene or alicyclic moiety, C is a single bond, —O—, —COO—, —CONH— or —OCO—, D is a single bond or a benzene or alicyclic moiety, and R is a C₁-C₂₀ linear alkyl, branched or alicyclic alkyl group which is unsubstituted or substituted with at least one halogen atom.

15. A liquid crystal alignment layer formed by applying to a substrate a liquid crystal aligning agent comprising:
a polyamic acid represented by Formula 1: 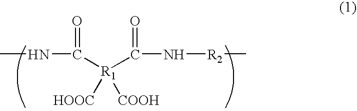
wherein R₁ is a tetravalent organic group derived from an alicyclic or aromatic dianhydride and R₂ is a divalent organic group derived from an aromatic diamine, a polyimide of Formula 2 which is prepared by imidization of the polyamic acid: 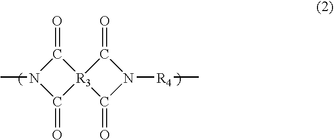
wherein R₃ is a tetravalent organic group derived from an alicyclic or aromatic dianhydride and R₄ is a divalent organic group derived from an aromatic diamine, or a mixture thereof;
an aprotic polar solvent as a first solvent; and
dipropylene glycol dimethyl ether or monoethylene glycol dimethyl ether as a second solvent.

16. A liquid crystal display device comprising a substantially uniform liquid crystal alignment layer on a surface of a transparent substrate, the liquid crystal alignment layer comprising a polyimide of Formula 2 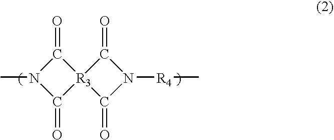
wherein R₃ is a tetravalent organic group derived from an alicyclic or aromatic dianhydride and R₄ is a divalent organic group derived from an aromatic diamine, wherein said alignment layer is substantially free of solvents and exhibits a variation in thickness of less than 0.005 μm.

17. A liquid crystal display device comprising a liquid crystal alignment layer formed by applying to a substrate a liquid crystal aligning agent comprising:
a polyamic acid represented by Formula 1: 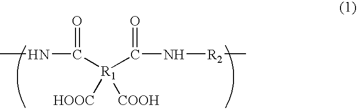
wherein R₁ is a tetravalent organic group derived from an alicyclic or aromatic dianhydride and R₂ is a divalent organic group derived from an aromatic diamine, a polyimide of Formula 2 which is prepared by imidization of the polyamic acid: 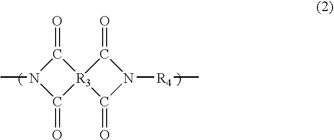
wherein R₃ is a tetravalent organic group derived from an alicyclic or aromatic dianhydride and R₄ is a divalent organic group derived from an aromatic diamine, or a mixture thereof;
an aprotic polar solvent as a first solvent; and
dipropylene glycol dimethyl ether or monoethylene glycol dimethyl ether as a second solvent.
